(19) United States
(12) Patent Application Publication
(10) Pub. No.: US 2015/0223640 A1
(43) Pub. Date: Aug. 13, 2015

(54) Whisk with Improved Aeration

(71) Applicant: Sunbeam Products, Inc., Boca Raton, FL (US)

(72) Inventor: George Choy, Kowloon (HK)

(73) Assignee: Sunbeam Products, Inc., Boca Raton, FL (US)

(21) Appl. No.: 14/619,444

(22) Filed: Feb. 11, 2015

Related U.S. Application Data
(60) Provisional application No. 61/939,017, filed on Feb. 12, 2014.

(51) Int. Cl. A47J 43/044

(52) U.S. Cl. CPC A47J 43/044; A47J 2043/04454

(57) ABSTRACT

A whisk for attachment to a blending appliance including a shaft configured to connect to a source of rotary power, a plurality of flexible filament loops, and a coupling for connecting the shaft to the plurality of filament loops. The plurality of filament loops extend downwardly from the coupling to form a cage. A stem extends downwardly from the coupling in axial alignment with the shaft and disposed centrally within the cage. The stem limits deformation of the plurality of filament loops when force is applied to the shaft of the whisk.

### CROSS-REFERENCE TO RELATED APPLICATION

The present application claims priority to U.S. Provisional Patent Application No. 61/939,017 filed Feb. 12, 2014, entitled “Whisk With Improved Aeration”.

### FIELD OF THE INVENTION

The invention relates to cooking devices. More particularly, the invention relates to an improved whisk for preparing food with deformable filament loops for enhanced aeration of the food and a stem that prevents damage to the filament loops if too much pressure is placed onto the whisk.

### BACKGROUND OF THE INVENTION

Whisks used to blend, smooth and aerate food are known. A whisk works by manipulating the surface tension of liquids and then adding air into the food mixture. Adding air to the food mixture significantly changes the surface area of the food and enhances the taste of the food. The use of a whisk also drastically increases the volume of the food. As a result, creamy foods such as whip cream, meringues, omelets, mayonnaise, soufflés, gravy and the like can be made. Such whisks may be hand or electric powered. The more air that is aerated into the food, the fluffier the food.

### SUMMARY OF THE INVENTION

In an embodiment, there is provided a blending and mixing implement including a shaft configured to connect to a source of rotary power, a a plurality of flexible filament loops, and a coupling for connecting the shaft to the plurality of filament loops. The plurality of filament loops extend downwardly from the coupling to form a cage. A stem extends downwardly from the coupling in axial alignment with the shaft and disposed centrally within the cage. The stem limits deformation of the plurality of filament loops when force is applied to the shaft.

In an embodiment, there is provided a whisk for attachment to a mixing appliance including a shaft having a first end configured to attach to the mixing appliance, at least one flexible filament loop connected to a second end of the shaft, and a stem downwardly extending from the second end of the shaft and in axial alignment therewith. The stem limits deformation of the filament loop when force is applied to the shaft.

In an embodiment, there is provided a method of whisking and aerating food including the steps of attaching a whisk to a source of rotary power, inserting the whisk into a container containing food to be whisked, urging the whisk against a bottom of the container such that at least one filament loop is deformed until a stem on the whisk contacts the bottom of the container, and rotating the whisk to blend and aerate the food in the container.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a perspective view of an improved whisk mounted on a conventional stand mixer;

FIG. 2 is a side view of the whisk of FIG. 1 shown detached from the stand mixer of FIG. 1;

FIG. 3 is an exploded perspective view of the whisk of FIG. 1;

FIG. 4 is a side view of the whisk of FIG. 1 in the normal configuration;

FIG. 5 is a side view of the whisk of FIG. 1 in the in use or deformed configuration; and

FIG. 6 is a bottom view of the whisk of FIGS. 1 and 5 in the in use or deformed configuration.

### DETAILED DESCRIPTION OF THE INVENTION

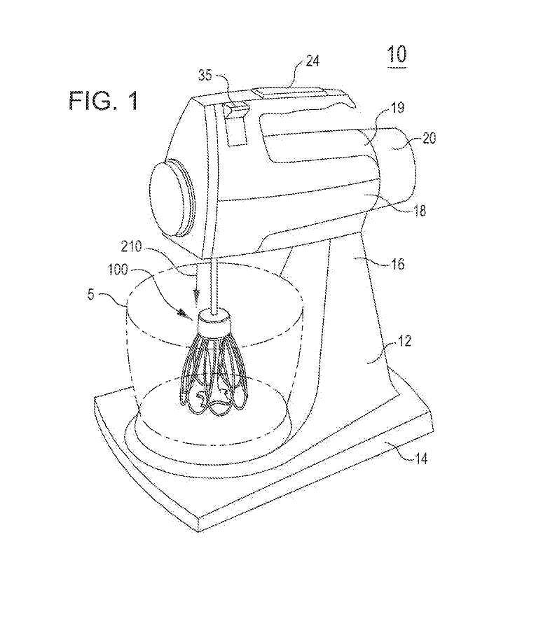

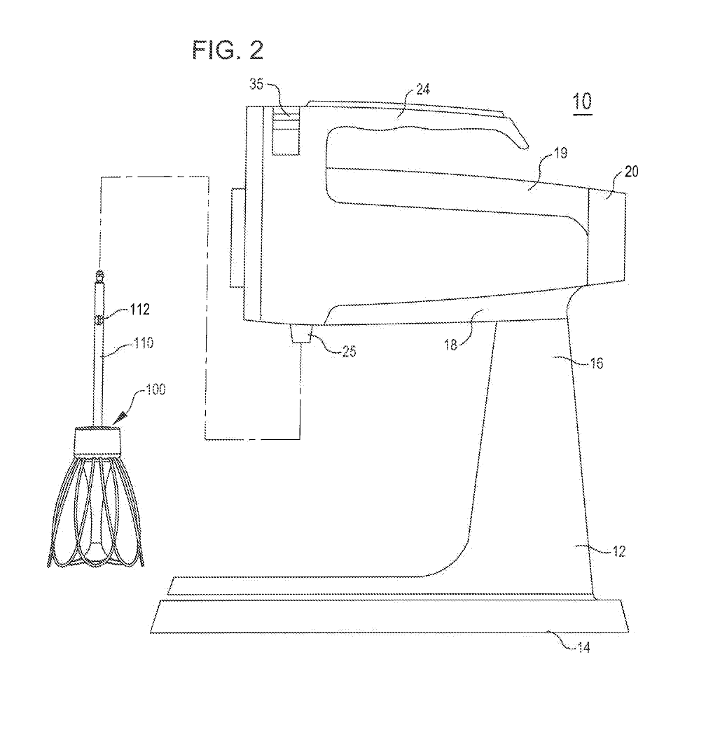

Referring now to FIGS. 1 and 2 of the drawings, in an embodiment there is illustrated an improved whisk 100 installed in a stand mixer 10. The stand mixer 10 is of a conventional type and may include a stand 12 with a base 14 and a hollow upright or pedestal 16 formed integral therewith. A mixing head 18 containing an alternating current electrical motor (not shown) is pivotally mounted on upright 16. The mixing head 18 has a generally cylindrical portion 19 and includes a speed control knob 20 mounted at a rear portion thereof for controlling the electrical motor (not shown). The whisk 100 is releasably mounted in mixer head 18 for rotation thereby. The mixer head 18 also includes an integral handle 24. A similar or identical stand mixer is disclosed in U.S. Pat. No. 4,277,181, which is incorporated by reference as if fully set forth herein.

In order to drive the whisk 100, the electrical motor (not shown) is rotatably connected to a spindle 25 on the underside of the mixing head 18 through appropriate gearing (not shown). A proximal end of the shaft 110 of the whisk 100 is removably fitted in the spindle 25. In an embodiment, the spindle 25 includes one or more keyways (not shown) formed therein to receive mating keys 112 on the shaft 110 of the whisk 100 adapted for driving engagement therewith. There is an ejector button 35 which is depressed to eject the shaft 110 of the whisk 100 from the spindle 25. There are many well-known means in the art utilized for the attachment and detachment of a mixing attachment such as the whisk 100 to and from the spindle 25 of a mixer 10 and any of such means may be utilized herein.

In another embodiment, the whisk 100 may be attached to an electric hand mixer (not shown) having a spindle (not shown) in which the proximal end of the shaft 110 of the whisk 100 is removably fitted. In yet another embodiment, the whisk 100 may be attached to an electric stick mixer (not shown) having a spindle (not shown) in which the proximal end of the shaft 110 of the whisk 100 is removably fitted. The electric stick mixer (not shown) may be powered by electrical power from a conventional source of electrical power or batteries (both replaceable or rechargeable types). In yet another embodiment, the whisk 100 may be attached to or integrally formed as part of a non-electric manual hand mixer (not shown). Typically, these types of mixers include a hand powered crank and gearing which rotate the whisk to blend, smooth and aerate ingredients. Note that the whisk 100 may be attached to any type of device having a source of motive power to rotate the whisk 100 to perform the blending, smoothing and aerating operations on food being prepared as described below.

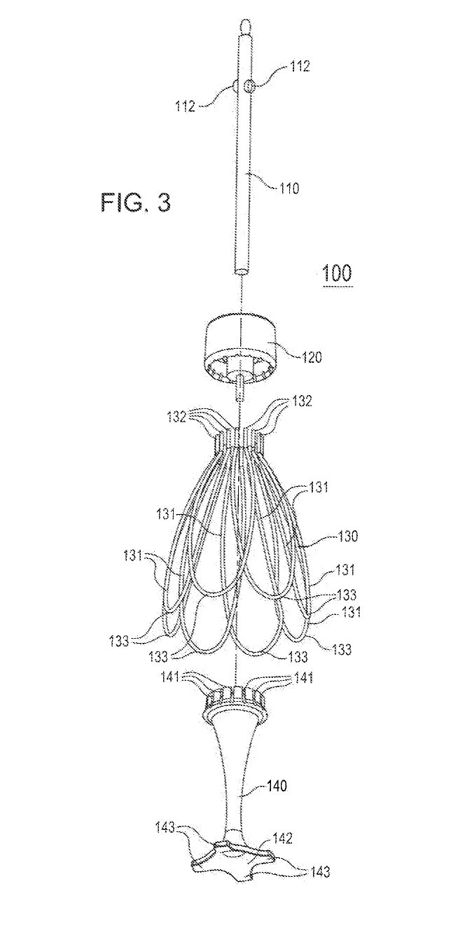

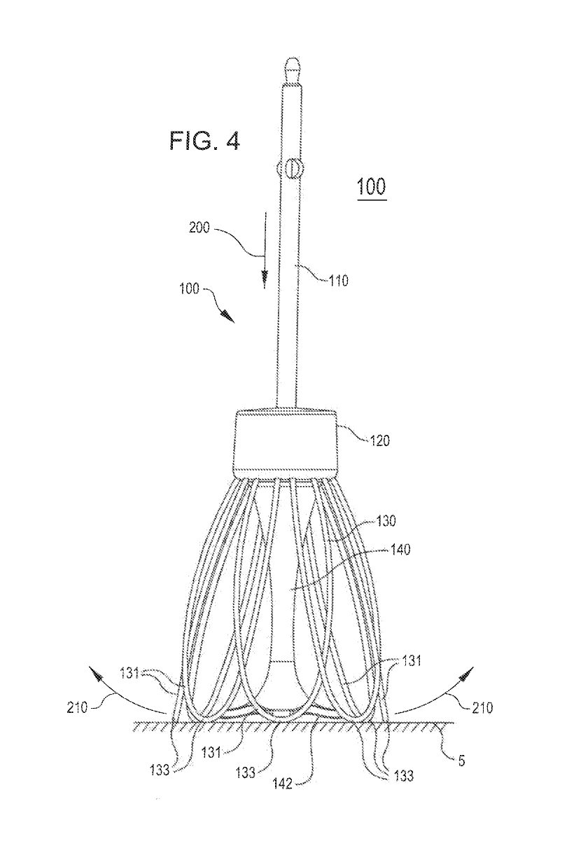

Referring now to FIGS. 3 and 4, in an embodiment there is illustrated an exploded view of the whisk 100. The whisk 100 is comprised of the shaft 110 having the keyed portions 112 on the proximal end which fit into the spindle 25 of the mixer 25 or any of the foregoing embodiments of an electric or non-electric mixer. The whisk 100 also includes a filament loop portion 130 comprised of a plurality of filament loops 131 formed into a cage 130 with each filament loop 131 having a u-shaped bottom end 133 and two free ends 132. In an embodiment, the plurality of filament loops 131 are comprised of metal wire including but not limited to stainless steel. In an embodiment, the plurality of filament loops 131 are comprised of plastic, bamboo or nylon. The whisk 100 also includes a stem 140 having a plurality of slots 141 at a top end for receiving the ends 132 of the plurality of filament loops 131. The stem 140 is centrally disposed within the cage formed by the filament loops 131. The stem 140 is co-axial with the shaft 110. The stem 140 has a lower end with a base portion 142 that engages the bottom of the mixing container 5 (see also FIG. 1) used to hold the food to be blended by the whisk 100. A plurality of feet 143 extend from the base portion 142. The whisk 100 also includes a collar 120 that secures the plurality of filament loop portions 131 into the slots 141 at the top end of the stem 140. The collar 120 also includes an aperture (not shown) which receives the distal end of the shaft 110 for connecting the shaft 110 to the plurality of filament loops 131.

The whisk 100 is a cooking utensil used in food preparation to blend ingredients smooth, or to incorporate air into a mixture, in a process known as whisking. Most whisks consist of a long, narrow handle with a series of filament loops joined at the end. The plurality of filament loops are typically comprised of metal wire including but not limited to stainless steel, but some are made from filaments of plastic, bamboo or nylon for use with nonstick cookware. Whisks are commonly used to whip egg whites into a firm foam to make meringue, of to whip cream into whipped cream. Whisks have differently-shaped filament loops depending on their intended functions. For example, the most common shape is that of a wide teardrop, termed a balloon whisk. Balloon whisks are best suited to mixing in bowls, as their curved edges conform to a bowl's concave sides. In an embodiment, the whisk 100 is of this type.

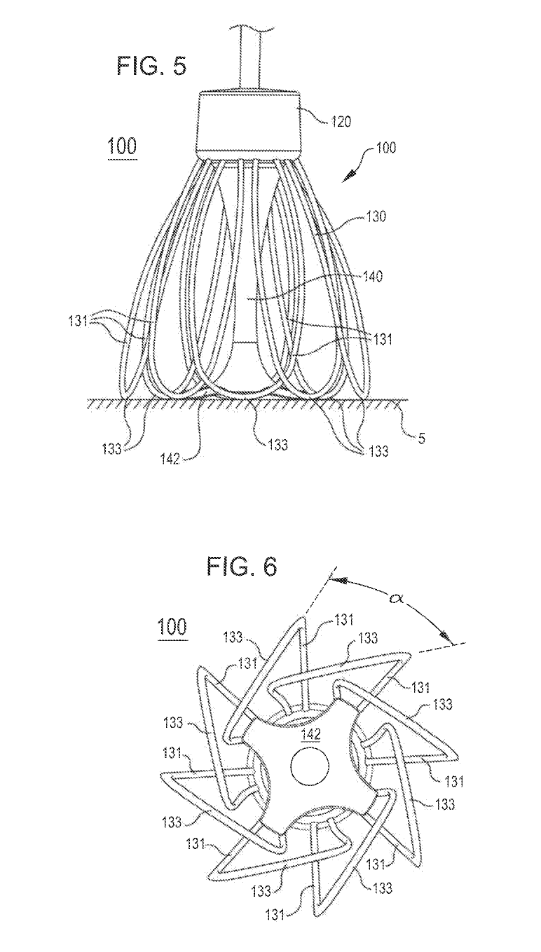

In an embodiment, the whisk 100 is inserted into the spindle 25. The whisk 100 is rotated by energizing the electrical motor (not shown) by rotating the control knob 20 to a desired speed setting measured in revolutions-per-minute (RPM's). The cage 130 of the whisk 100 is inserted into the mixing container 5 which may also be mounted on the stand 12. When the proximal end of the shaft 110 of the whisk 100 is installed in the spindle 25 as shown in FIG. 1 and the cage 130 is inserted into the mixing container 5, the mixing head 18 normally imparts a downward force in the direction of arrow 210 on the proximal end of the shaft 110 causing the U-shaped ends 133 of the plurality of filament loops 131 to be urged against the bottom of the mixing container 5. Normally, the u-shaped ends 133 of the filament loops 131 are slightly longer than the length of the stem 140 and base portion 142. As such, the plurality of filament loops 131 forming the cage 130 are urged against the bottom of the mixing container 5 when the shaft 110 of the whisk 100 is installed in the mixing head 18 as shown in FIG. 1. This causes a displacement of the U-shaped ends 133 of the filament loops 131 in the direction of arrows 210. This displacement also causes a twisting of the filament loops 131 from their normal position as shown in FIG. 4 to an offset angular position as shown in FIGS. 5 and 6 where the angular offset is represented by the symbol a. The angular offset a is typically in the range 0° to 10° but may may any angle or any range of angles.

The offset angular deformation of the filament loops 131 causes improved aeration of the food being blended by the whisk 100 as it is rotated resulting in fluffier foods. At the same time, the feet 143 on the base portion 142 of the stem 140 engage the bottom of the container 5 such that the filament loops 131 of the whisk 100 are prevented from being deformed too far in the direction of arrows 210 to prevent damage to the filament loops 131. When in the maximum deformed configuration, the U-shaped ends 133 of the filament loops 131 are in the same plane as the bottom of the base portion 142 of the stem 140 as shown in FIG. 5.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. A blending and mixing implement, comprising:
a shaft configured to connect to a source of rotary power;
a plurality of flexible filament loops;
a coupling for connecting the shaft to the plurality of filament loops, the plurality of filament loops extending downwardly from the coupling to form a cage; and
a stem downwardly extending from the coupling in axial alignment with the shaft and disposed centrally within the cage;
wherein the stem limits deformation of the plurality of filament loops when force is applied to the shaft.

2. The blending and mixing implement of claim 1, wherein the filament loops are comprised of wire formed from a metal.

3. The blending and mixing implement of claim 2, wherein the metal is stainless steel.

4. The blending and mixing implement of claim 1, wherein the filament loops are comprised of a material selected from the group consisting of nylon, plastic and bamboo.

5. A whisk for attachment to a mixing appliance, comprising:
a shaft having a first end configured to attach to the mixing appliance;
at least one flexible filament loop connected to a second end of the shaft; and
a stem downwardly extending from the second end of the shaft and in axial alignment therewith;
wherein said stem limits deformation of the filament loop when force is applied to the shaft.

6. The whisk of claim 5, further comprising a coupling connecting the shaft to the at least one flexible filament.

7. The whisk of claim 5, wherein the at least one filament loop is a plurality of filament loops.

8. The blending and mixing implement of claim 5, wherein the filament loops are comprised of wire formed from a metal.

9. The blending and mixing implement of claim 8, wherein the metal is stainless steel.

10. The blending and mixing implement of claim 5, wherein the filament loops are comprised of a material selected from the group consisting of nylon, plastic and bamboo.

11. A method of whisking and aerating food, comprising the steps of:
attaching a whisk to a source of rotary power;
inserting the whisk into a container containing food to be whisked;
urging the whisk against a bottom of the container such that at least one filament loop is deformed until a stem on the whisk contacts the bottom of the container; and
rotating the whisk to blend and aerate the food in the container.

12. The method of whisking and aerating food of claim 11, further comprising the step of discontinuing rotating the whisk.

13. The method of whisking and aerating food of claim 12, further comprising the step of:
detaching the whisk from the source of rotary power.

14. The method of whisking and aerating food of claim 11, further comprising the step of:
selecting the material comprising the filament loop to be wire made from a metal.

15. The method of whisking and aerating food of claim 14, further comprising the step of selecting the material comprising the filament loop to be stainless steel.

16. The method of whisking and aerating food of claim 11, further comprising the step of:
selecting the material comprising the filament loops from the group consisting of nylon, plastic and bamboo.
